(19) United States
(12) Patent Application Publication
(10) Pub. No.: US 2018/0160459 A1
(43) Pub. Date: Jun. 7, 2018

(54) METHOD AND APPARATUS FOR COOPERATIVE MICROSLEEP OPERATION

(71) Applicant: Motorola Mobility LLC, Chicago, IL (US)

(72) Inventors: Victor Fernandes Cavalcante, Campinas (BR); Benicio Pereira Goulart, Campinas (BR); Raul Palacios Trujillo, Barcelona (ES); Nelson L.S. Fonseca, Campinas (BR)

(21) Appl. No.: 15/367,190

(22) Filed: Dec. 2, 2016

(51) Int. Cl. H04W 76/04; H04W 52/02

(52) U.S. Cl. CPC H04W 76/046; H04W 52/0251

(57) ABSTRACT

A method and apparatus provide for cooperative microsleep operation. A first wireless communication device can communicate with a second wireless communication device in a wireless communication network having a duration of data transmission. The first wireless communication device can receive information about a third wireless communication device operating in the wireless communication network. The information can include at least one transition time between awake and sleep states of a radio transceiver of the third wireless communication device. The first wireless communication device can adjust the duration of the data transmission to the second wireless communication device based on at least one transition time between awake and sleep states of the radio transceiver of the third wireless communication device.

### BACKGROUND

### 1. Field

The present disclosure is directed to a method and apparatus for cooperative microsleep operation. More particularly, the present disclosure is directed to a method and apparatus for cooperative microsleep operation of wireless communication devices operating in a wireless communication network.

### 2. Introduction

Presently, wireless communication devices, such as smailphones, computers, connected home devices, tablets, access points, base stations, and other wireless communication devices, communicate with other communication devices using radio transceivers that send and receive wireless signals over a wireless network. These devices have batteries that must be periodically charged to power the devices. The more often a device is used, the more frequently the battery must be charged. This creates a problem when a device is used often enough to drain the battery completely before it can be recharged. Even when a user is not actively using a device, a radio transceiver on a wireless communication device drains the battery because it is constantly monitoring for available communication channels and signals sent to it from other devices.

To conserve energy and extend battery life, a radio transceiver of a given device enters a low power state called doze state (hereafter referred to as sleep state) for a predefined period of time. The given device makes the decision to sleep when it determines that on a channel shared with other devices no transmissions are directed to it, and it has no data to send to the other devices. The radio transceiver of a given device switches from the sleep state to a full power state called awake state periodically when the given device expects to receive data from the other devices, or whenever it has data to send to the other devices. This operation was introduced in the IEEE 802.11 Standard through a Power Save Mode (PSM).

While a given device remains awake to transmit and/or receive data, it can receive data addressed to other devices when other devices transmit on a shared channel This action is referred to as overhearing and consumes a significant amount of the energy resources of the given device during active periods.

To address this issue, a given device can sleep during transmissions on a shared channel that are directed to other devices. This operation is referred to as microsleep since it allows sleep periods in the order of tens, hundreds, or thousands of microseconds. Microsleep was introduced in the 802.11n amendment via a Power Save Multi-Poll (PSMP) method. Then, it was extended in the 802.11ac amendment through a Transmission Opportunity Power Save Mode (TXOP PSM).

Unfortunately, devices frequently do not take advantage of microsleep due to energy demands and time delays for the radio transceivers to enter and exit the sleep state, which results in less battery life. This is because transitions between awake and sleep states take time and consume power and there is a peak of power consumption in a sleep to awake transition. Microsleep is feasible only if the duration of a transmission is longer than the transition time between awake and sleep states. The transmission duration depends on the transmission data length and the Physical (PHY) data transmission rate used. As PHY data transmission rates increase due to more advanced communication protocols, the transmission times decrease, thus compromising the feasibility of microsleep. This is also because the transition times and power consumption can depend on radio hardware design, which is different for different devices.

### BRIEF DESCRIPTION OF THE DRAWINGS

In order to describe the manner in which advantages and features of the disclosure can be obtained, a description of the disclosure is rendered by reference to specific embodiments thereof which are illustrated in the appended drawings. These drawings depict only example embodiments of the disclosure and are not therefore to be considered to be limiting of its scope. The drawings may have been simplified for clarity and are not necessarily drawn to scale.

FIG. 1 is an example block diagram of a system according to a possible embodiment;

FIG. 2 is an example timeline of signals and operations of wireless communication devices and an access point using a reverse direction transmission mode on a channel according to a possible embodiment;

FIGS. 3A and 3B illustrate an example timeline of signals and operations of wireless communication devices and an access point using a burst transmission on a channel according to a possible embodiment;

FIG. 4 is an example timeline of signals and operations of wireless communication devices and an access point using multiple reverse direction transmissions on a channel according to a possible embodiment;

FIG. 5 is an example flowchart illustrating the operation of a wireless communication device when it is communicating with a second device on a channel and there is a third device listening to the communication according to a possible embodiment;

FIG. 6 is an example flowchart illustrating the operation of a wireless communication device when it is listening to the communication occurring on one or various channels between other devices according to a possible embodiment; and

FIG. 7 is an example block diagram of an apparatus according to a possible embodiment.

### DETAILED DESCRIPTION

Embodiments provide a method and apparatus for cooperative microsleep operation. According to a possible embodiment, a first wireless communication device can communicate with a second wireless communication device in a wireless communication network having a duration of data transmission. The first wireless communication device can receive information about a third wireless communication device operating in the wireless communication network. The information can include at least one transition time between awake and sleep states of a radio transceiver of the third wireless communication device. The first wireless communication device can adjust the duration of the data transmission to the second wireless communication device based on at least one transition time between awake and sleep states of the radio transceiver of the third wireless communication device.

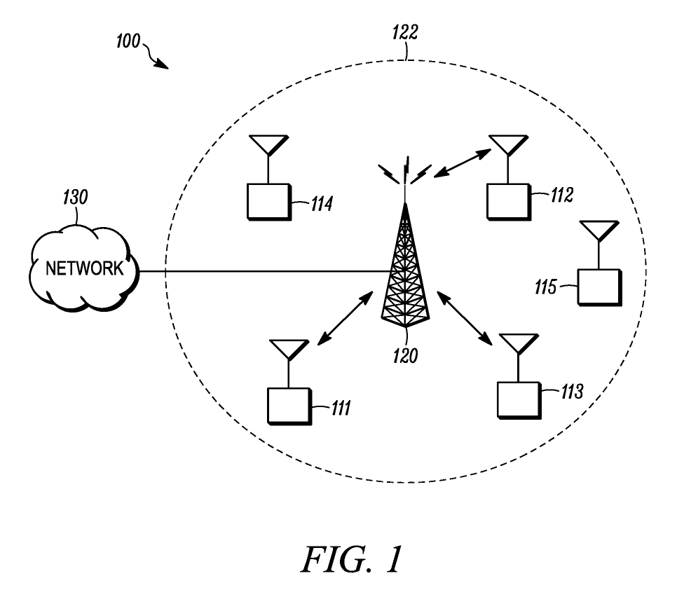

FIG. 1 is an example block diagram of a system 100 according to a possible embodiment. The system 100 can include wireless communication devices 111-115, an Access Point (AP) 120, and a network 130. Each of the wireless communication devices 111-115 can be a wireless terminal, an 802.11 station, a portable wireless communication device, a smartphone, a cellular telephone, a flip phone, a personal digital assistant, a personal computer, a television, a video game console, a projector, a selective call receiver, a tablet computer, a laptop computer, wearable devices, Internet of Things (IoT) devices, or any other device that is capable of sending and receiving communication signals on a wireless network. Some of the wireless communication devices 111-115 can also be wireless personal area network devices, such as near field communication 802.15 headsets, computing devices, keyboards, mice, remotes, and other near field communication devices.

The AP 120 can be an 802.11-based AP, a wireless router, a Wireless Local Area Network (WLAN) AP, a wireless personal area network AP, a cellular network base station, or any other wireless communication AP. The AP 120 can cover a basic service coverage area 122. One or more of the wireless communication devices 111-115 can also act as APs, such as mobile hot spots or wireless personal area network APs. The network 130 can include any type of network that is capable of sending and receiving communication signals. For example, the network 130 can include a wireless communication network, the Internet, a packet-based network, a cellular telephone network, a satellite communications network, a high altitude platform network, and/or other communications networks.

In operation, the wireless communication devices 111-115 can communicate with the AP 120, each other, and the network 130 and exchange information in the basic service coverage area 122 using wireless communication signals, such as 802.11 signals, 802.15 signals, near field communication signals, cellular signals, and other wireless communication signals. According to some embodiments, a device can communicate using a Transmission Opportunity (TXOP) for Enhanced Distributed Channel Access (EDCA) defined in 802.11e, where EDCA can prioritize channel access and occupancy time for different traffic classes, such as by prioritizing traffic classes that are more sensitive to latency, such as conversational voice, video, real time gaming, and other classes that are more sensitive to latency, over other traffic classes that are less sensitive to latency, such as buffered streaming non-conversational video, e-mail, webpage data, and other classes that are less sensitive to latency. EDCA can use frame bursting and frame aggregation, such as Medium Access Control (MAC) Service Data Unit (MSDU) aggregation and MAC Protocol Data Unit (MPDU) aggregation. Also, a device can be a transmitting device that uses an RD protocol defined in 802.11n. This protocol can allow the transmitting device to grant an unused portion of its TXOP to a receiving device, which can allow the receiving device to send data back to the transmitting device. In a Power Save Multi-Poll (PSMP) defined in 802.11n and a TXOP Power Save Mode (PSM) defined in 802.11ac, an AP, such as the AP 120, can enable non-transmitting and receiving devices to microsleep during a TXOP where a radio transceiver of a device powers down for a short period while another device or devices has or have the TXOP. Microsleep operation can be feasible when the transmission duration of a TXOP is longer than the duration of awake/sleep state transitions of the radio transceiver. Awake and sleep transitions, including a transition time between awake and sleep states, include both a transition from awake to sleep state and a transition from sleep to awake state. Disclosed cooperative microsleep embodiments can take into account the duration of awake/sleep state transitions of devices that are not transmitting and/or receiving. Cooperative microsleep can be used in networks with high traffic loads, in dense networks, and other systems. Cooperative microsleep can extend a device transmission time during channel access to allow other devices to enter a sleep state at the beginning of a transmission addressed to another device and return to an awake state at the end of the transmission.

For example, the device 111 can be a source device, such as a transmitting device, the device 112 can be a destination device, such as a receiving device, and the device 113 can be a listening device, such as an overhearing device. The source device 111 can transmit to the destination device 112 and can choose a transmission duration by adjusting amount of data and/or data rate in order to enable microsleep for the listening device 113 based on transition delays and energy requirements of the listening device 113. According to a related embodiment, the destination device 112 can respond to data received from the source device 111 and can choose a transmission duration by adjusting amount of data and/or data rate in order to enable microsleep for the listening device 113 based on transition delays and energy requirements of the listening device 113. These embodiments can also be performed with multiple destination devices. According to a related embodiment, in a multi-channel environment, the listening device 113 can choose one of a plurality of busy channels by selecting the channel with the lowest occupancy time if it has data to transmit and selecting the channel with the highest occupancy time if it has no data to transmit.

Embodiments can allow a transmitting device to adjust a transmission frame length and/or Physical (PHY) data transmission rate. Embodiments can also allow a transmitting device to hold or aggregate frames in order to perform multiple transmissions to a receiving device, such as by using burst transmission, frame aggregation, and/or other methods of adjusting a transmission frame length and/or PHY data transmission rate. Embodiments can additionally allow a receiving device to respond with a data frame of arbitrary length with a piggybacked ACK frame back to the transmitting device for one or more RD transmissions. Embodiments can further allow a receiving device to initiate a data transmission phase in which it exchanges data with multiple devices that can microsleep in a frame exchange basis. Embodiments can also allow for cooperative microsleep in multiple channels, where a device receiving data addressed to other devices in difference channels can microsleep by selecting a channel with an occupancy time that better suits its instantaneous traffic requirements. For example, the device can select a channel with a shortest occupancy time when it has data to transmit or a channel with a longest occupancy time when it has no data to transmit to maximize its microsleep period.

According to possible embodiments, a device that is not sending or receiving data can employ a Network Allocation Vector (NAV) timer, which can represent the number of microseconds a transmitting device intends to hold the medium busy. For example, a NAV Request to Send (RTS) timer can be the NAV timer triggered by overhearing an RTS frame transmitted by a transmitting device. Overhearing can include receiving a frame addressed to another device. This NAV timer can be set for the period of microsleep of an idle device when an RD transmission mode is supported in a wireless network, where an RD transmission mode can allow two devices to exchange data when one of them gains access to the shared channel If the RD transmission mode is not supported, each device may have to gain access to the shared channel to send data to the other device. This NAV timer can also be similarly set when an RD mode is supported.

For an example with three devices, referred to as stations (STAs) including STA A, STA B, and STA C, one device, STA A, can have a data frame addressed to STA B, STA B can have a data frame addressed to STA A, and STA C can have no data to transmit. If an RD mode is not supported and STA A can gain access to the shared channel to send a data frame to STA B after a Distributed Coordination Function Interframe Space (DIFS), STA A can first send an RTS frame to STA B. Upon successful reception of the RTS frame, STA B can respond with a Clear to Send (CTS) frame after a Short Interframe Space (SIFS) period. Then, STA A can send the data frame after another SIFS period. Finally, STA B can reply with a positive Acknowledgement (ACK) frame after a SIFS period. The transmission sequence can be RTS+SIFS+CTS+SIFS+DATA+SIFS+ACK.

STA A can indicate the expected transmission duration in a duration field contained in a MAC header of the RTS frame. Then, STA B can update the value of the duration field contained in the MAC header of the CTS frame to the remaining transmission duration. After that, STA A can do the same with the duration field contained in the MAC header of the data frame. If STA C receives the RTS frame addressed to STA B, it can set its NAV timer to the duration value included in the RTS frame (NAV RTS=SIFS+CTS+SIFS+DATA+SIFS+ACK). Then, STA C, such as a radio transceiver in STA C, can attempt to sleep based on the NAV timer.

If STA C does not receive the RTS frame, it can wait to receive a subsequent frame. If it receives the CTS frame, it can set its NAV timer to the duration value contained in the CTS frame (NAV CTS: SIFS+DATA+SIFS+ACK). Then, it can attempt to sleep based on the NAV timer. If STA C does not receive the CTS frame, it may receive a data frame. Then, it can set the NAV timer to the duration included in the DATA frame (NAV DATA=SIFS+ACK) and attempt to sleep based on the NAV timer. If STA C cannot set its NAV timer, it may not be able to sleep during the transmission. This NAV timer setting procedure, as well as RTS, CTS, ACK, DIFS, and SIFS can be defined by the 802.11 Standard.

According to a possible embodiment, a wireless communication device can communicate with multiple wireless communication devices simultaneously using network coding. The device can combine data intended for different devices together in a single data transmission using a given coding operation, such as XOR. The network coded data transmission can provide information to allow successfully decoding the original data at all intended devices using a given coding operation, such as XOR. According to a related possible embodiment, a wireless communication device sending data/network coded data can extend a duration of a data/network coded data transmission in each successful channel access attempt. This extension of the transmission duration can be performed by adjusting the amount of transmitted data/network coded data and/or the PHY data transmission rate so that other wireless communication devices can microsleep. The extended transmission duration can consider the non-negligible delay and energy of the awake/sleep state transitions of the other wireless communication devices. This can allow the other wireless communication devices to enter the sleep state at the beginning of a transmission addressed to another device and return to the awake state at the end of the transmission. According to a related possible embodiment, a wireless communication device receiving data/network coded data can initiate a data/network coded data transmission. The duration of such transmission can be extended by adjusting the amount of transmitted data/network coded data and/or the PHY data transmission rate. The extended transmission duration can account for the non-negligible delay and energy of the awake/sleep state transitions of other wireless communication devices that are not involved in the data exchange. The transmission duration can be extended so that the other wireless devices can enter the sleep state at the beginning of a transmission intended for another device and return to the awake state at the end of the transmission. According to a related possible embodiment, a wireless communication device receiving data/network coded data can initiate a data/network coded data transmission phase in which it exchanges data/network coded data with multiple devices. These devices can respond with data/network coded data when receiving data/network coded data from the other device, hence extending the occupancy time. This extension of the occupancy time can be based on the non-negligible time and energy of the awake/sleep transitions of devices that are not involved in the data exchanges. Such devices can then enter the sleep state at the beginning of the exchange and return to the awake state at the end of the exchange. According to a related possible embodiment, within a multi-channel environment a wireless communication device receiving data addressed to other wireless communication devices on different channels can microsleep. To determine the sleep period, the device can select the channel with the occupancy time that better suits its instantaneous traffic requirements. For example, it can select the channel with the shortest occupancy time if it has data to transmit or the longest occupancy time if it has no data to transmit to sleep longer. Different embodiments can be combined with each other and/or used separately. The device can then enter the sleep state at the beginning of a transmission directed to another device on a given channel and return to the awake state at the end of the transmission. The transmission duration can take into account the non-negligible delay and energy of the awake/sleep state transitions of the device.

Among other wireless communication systems, embodiments can be used with the 802.11n RD protocol where a wireless communication device that gains access to the channel for a reserved period time, referred to as TXOP, can grant permission to the other wireless device to which the data are destined to send data back during the unused part of its TXOP. In addition, the wireless communication device that holds a TXOP can exchange data with multiple wireless devices during its own TXOP. Embodiments can also be used with 802.11ac TXOP PSM where an 802.11ac wireless communication device can sleep, such as microsleep, during data transmissions addressed to other 802.11ac devices. Embodiments can further be used in a WLAN including an AP and a finite number of STAs located in its service area, where the AP can deliver data to the STAs and the STAs send data to the AP and where the data can include video conferencing, video streaming, peer-to-peer, FTP, voice, and other data. Embodiments can additionally be used in an ad hoc network where two or more wireless communication devices can exchange data and/or where one wireless communication device carries data addressed to all other wireless devices that also have data to transmit to it, such as for data dissemination, for file exchange, in areas of a country where there is no network infrastructure, and for other purposes in other wireless communication systems.

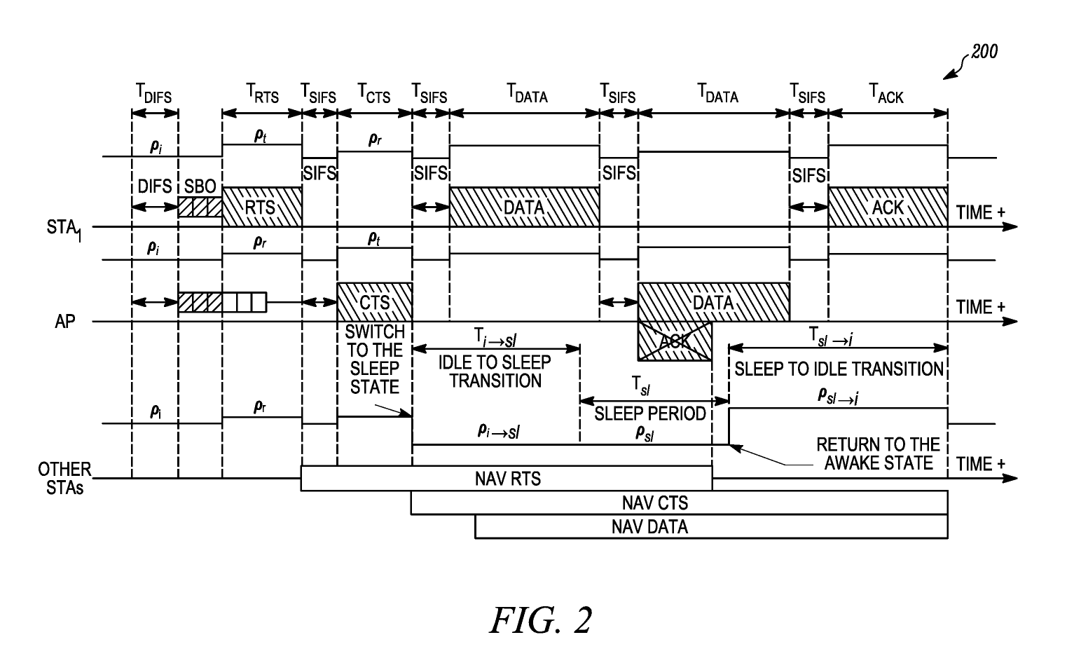

FIG. 2 is an example timeline 200 of signals and operations of wireless communication devices, such as STAs, and an AP using an RD mode on a shared channel according to a possible embodiment. The timeline 200 can include a DIFS period, a Slotted Backoff (SBO) time, an RTS frame, a SIFS period, a CTS frame, data frames, and an ACK frame. The timeline 200 can show time periods T_{DIFS}, T_{RTS}, T_{SIFS}, T_{CTS}, T_{DATA}, and T_{ACK} for the corresponding frames and interframe spaces, as well as a transition period from idle to sleep T_{i->sl}, a sleep period Tₛₗ, and a transition period from sleep to idle T_{sl->i}. The timeline 200 can also show power levels for idle power consumption pᵢ, transmitting power consumption pₜ, receiving power consumption pᵣ, transition from idle to sleep power consumption p_{i->sl}, sleep power consumption pₛₗ, and transition from sleep to idle power consumption p_{sl->i}. The timeline 200 can also show NAV timer periods, including NAV RTS, NAV CTS, and NAV DATA, triggered by different corresponding frames.

In operation according to an example, one STA, such as STA A, can gain access to the shared channel to send a data frame to another STA, STA B, or AP, where STA B will be used representatively in examples herein. STA A can first send an RTS frame to STA B, such as via the AP or directly to STA B. Also, STA A or STA B can be a client STA or an AP and either of them can be a client STA. Upon successful reception of the RTS frame, STA B can respond with a CTS frame after a SIFS period. When STA B has a data frame to send to STA A, it can extend the expected transmission duration to account for the RD transmission. This can be accomplished by updating a duration field of the CTS frame based on the duration value of the RTS frame. Then, STA A can send the data frame after another SIFS period. STA B can reply with another data frame (with an implicit ACK) after a SIFS period. Finally, STA A can send an (explicit) ACK frame to STA B. The transmission sequence can be RTS+SIFS+CTS+SIFS+DATA A->B+SIFS+DATA B->A+SIFS+ACK.

If another STA, STA C, receives the RTS frame addressed to STA B, it can set its NAV to the duration value included in the RTS frame (NAV RTS=SIFS+CTS+SIFS+DATA A->B+SIFS +ACK). Since the RD transmission mode is supported, STA C may not attempt to sleep until it receives a subsequent frame, such as either CTS or DATA, even if the microsleep operation is possible. For example, STA C may not go to sleep using the duration value included in the RTS frame because the CTS frame can provide a longer duration value than the RTS frame, which can allow STA C to sleep longer. If STA C receives the RTS frame, it can set its NAV timer to the duration value of the RTS frame. If STA C then receives the CTS frame after setting its NAV time to the duration value of the RTS frame, it can update its NAV timer to the extended duration value from the CTS frame. If STA C does not receive the RTS frame, it can wait to receive a subsequent frame. If it receives the CTS frame, it can set its NAV to the duration value contained in the CTS frame (NAV CTS: SIFS+DATA A->B+SIFS+DATA B->A+SIFS+ACK). Then, it may attempt to sleep based on the NAV timer. If it does not receive the CTS frame, it can receive a data frame and can set its NAV to the duration value contained in the data frame.

In the scenario without RD, STA C may sleep just upon receiving the RTS frame. In the scenario with RD, STA C can wait until it receives a CTS or DATA frame to know if there is a DATA B->A frame when determining its NAV for sleep. In the scenario with RD, STA C may just sleep based on the RTS frame where it may sleep shorter without exploiting the longer duration of the RD transmission. Since STA A does not know if STA B has data to send back in reverse direction, it can compute the expected transmission duration based on its own information. For example, the duration of the RTS frame can be SIFS+CTS+SIFS+DATA A->B+SIFS+ACK. Then, STA C can set its NAV based on the received RTS frame and attempt to sleep. If STA B has data to send back to STA A, STA B can respond with a CTS frame that includes an extended transmission duration value. The duration of the CTS frame can be SIFS+DATA A->B+SIFS+DATA B->A+SIFS+ACK. Then, STA C can update its NAV based on the received CTS frame and attempt to sleep, since NAV CTS is longer than NAV RTS.

If STA C does not receive the CTS frame, it may receive the DATA A->B frame. Then, it can set the NAV to the duration included in the DATA A->B frame (NAV DATA A->B=SIFS+DATA B->A+SIFS+ACK) and attempt to sleep based on the NAV timer. If STA C does not receive the DATA A->B frame, it may receive the DATA B->A frame. Then, it can set the NAV to the duration included in the DATA B->A frame (NAV DATA B->A=SIFS+ACK) and attempt to sleep based on the NAV timer. If STA C cannot set its NAV, it may not be able to sleep during the bidirectional transmission.

If the RD transmission mode is supported, the NAV CTS can be the primary relevant time period. If the RD transmission mode is not supported, the NAV RTS can be the primary relevant time period. In both cases, subsequent frames can also be used to enter the sleep state.

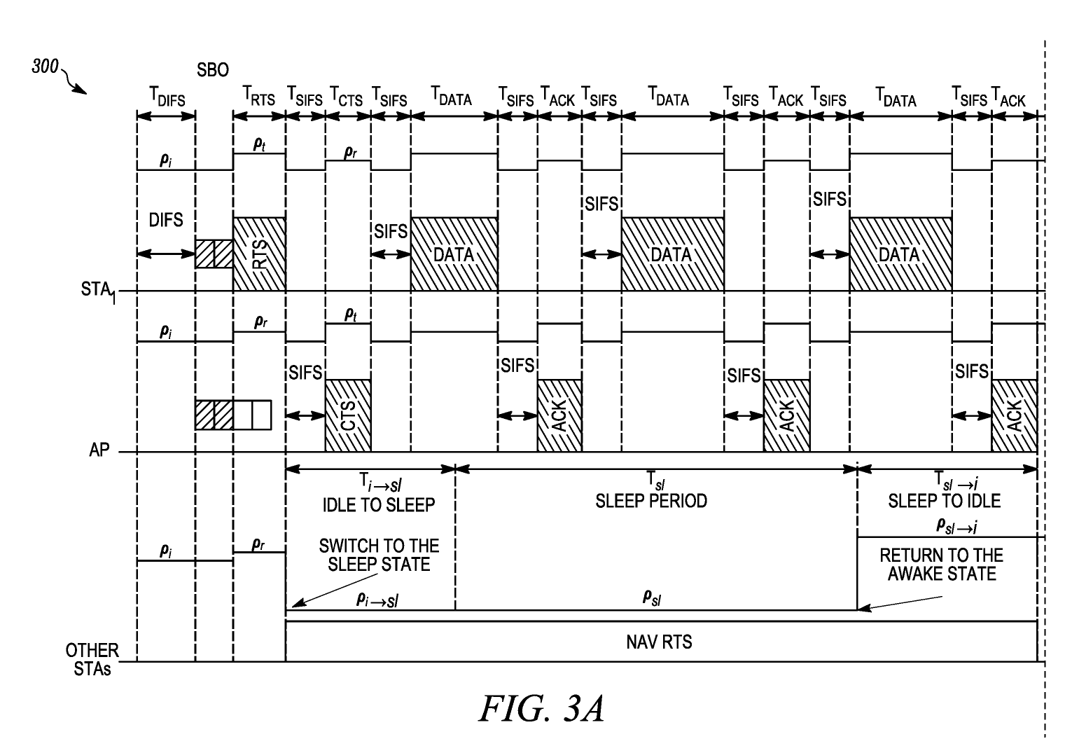

FIGS. 3A and 3B illustrate an example timeline 300 of signals and operations of wireless communication devices, such as STAs, and an AP using a burst transmission on a channel according to a possible embodiment. Similar to the timeline 200, the timeline 300 can include a DIFS period, an SBO time, a RTS frame, a SIFS period, a CTS frame, and various data and ACK frames along with the corresponding SIFS periods. The timeline 300 can show time periods T_{DIFS}, T_{RTS}, T_{SIFS}, T_{CTS}, T_{DADA}, and T_{ACK} for the corresponding frames and interframe spaces, as well as a transition period from idle to sleep T_{i->sl}, a sleep period Tₛₗ, and a transition period from sleep to idle T_{sl->i}. The timeline 300 can also show power levels for idle power consumption pᵢ, transmitting power consumption pᵢ, receiving power consumption pᵣ, transition from idle to sleep power consumption p_{i->sl}, sleep power consumption pₛₗ, and transition from sleep to idle power consumption p_{sl->i}. The timeline 300 can also show a NAV RTS timer period triggered by an RTS frame. The timeline 300 can show signals for burst transmission and microsleep operation, where operation is similar to operation of the timeline 200. For example, the timeline 300 can show one way to extend duration using frame bursting. With frame bursting, when a STA has data to send to an AP and the STA allocated more than one frame, the STA can send additional frames to extend the communication duration to allow radio transceivers of other STAs to sleep.

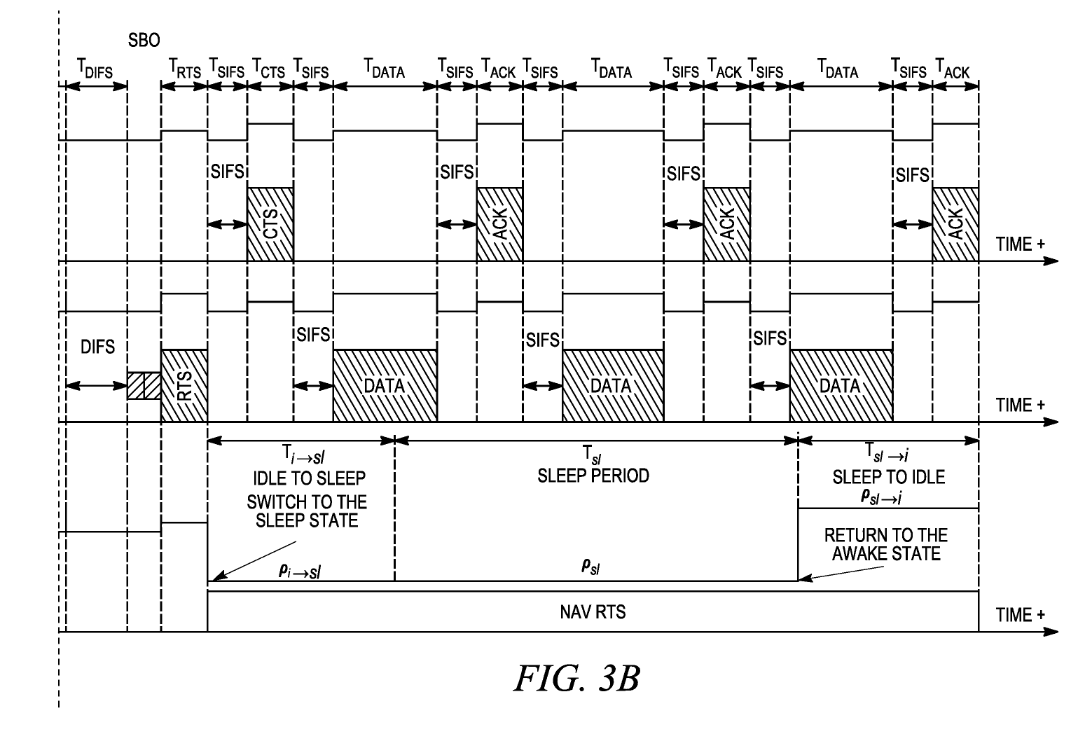

FIG. 4 is an example timeline 400 of signals and operations of wireless communication devices, such as STAs, and an AP using multiple RD transmissions on a channel according to a possible embodiment. Similar to the timelines 200 and 300, the timeline 400 can include a DIFS period, a SBO time, an RTS frame, a SIFS period, a CTS frame, and various data and ACK frames along with the corresponding SIFS periods. The timeline 400 can show time periods T_{DIFS}, T_{RTS}, T_{SIFS}, T_{CTS}, T_{DADA}, and T_{ACK} for the corresponding frames and interframe spaces, as well as a transition period from idle to sleep T_{i->sl}, a sleep period To, and a transition period from sleep to idle T_{sl->i}. The timeline 400 can also show power levels for idle power consumption pᵢ, transmitting power consumption pᵢ, receiving power consumption pᵣ, transition from idle to sleep power consumption p_{i->sl}, sleep power consumption pₛₗ, and transition from sleep to idle power consumption p_{sl->i}. The timeline 400 can also show NAV RTS/CTS/DATAs/ACKs timer periods triggered by RTS, CTS, DATA, and ACK frames. The timeline 300 can show signals for multiple RD transmissions and microsleep operation, where operation is similar to operation of the timelines 200 and 300.

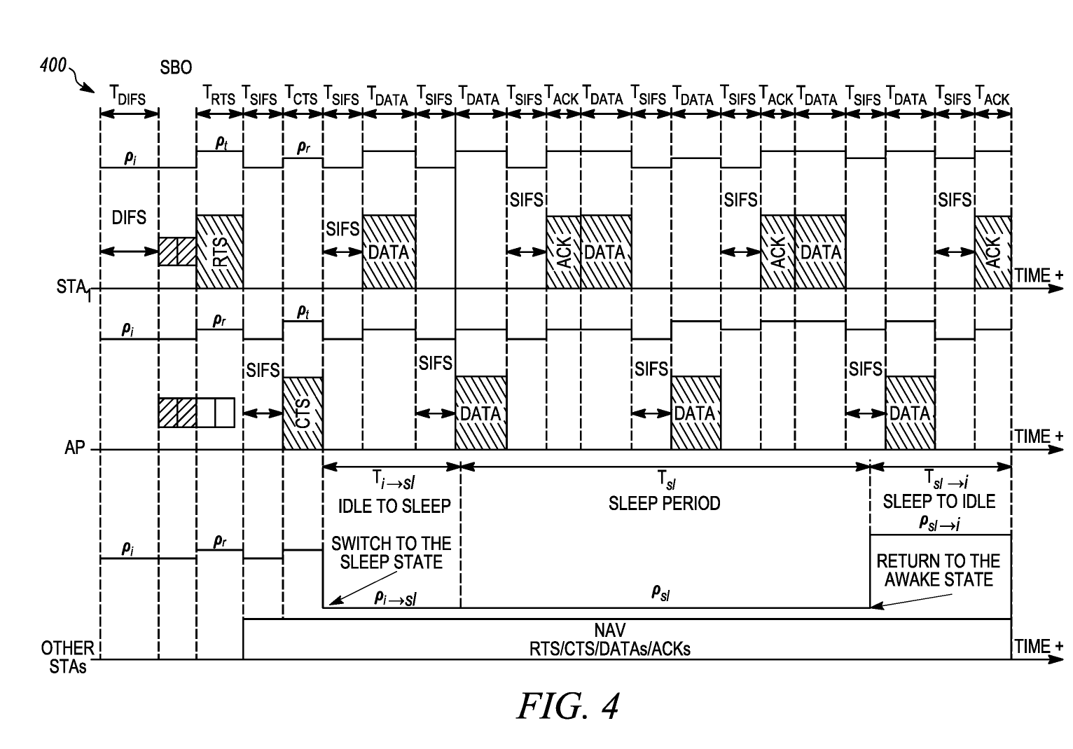

FIG. 5 is an example flowchart 500 illustrating the operation of a first wireless communication device, such as the device 111 or any other wireless communication device, according to a possible embodiment. Embodiments can be applied to one shared channel as well as multiple channels. At 510, a second wireless communication device can be communicated with in a wireless communication network having a duration of data transmission. For example, the duration of data transmission can be a time period of the data transmission. The duration can be a given duration, such as a set duration that can be predetermined, can be set by an AP, can be set by the second wireless communication device, a duration that does not take into account sleep and awake transition times, and/or can be any other duration. The communication can be performed on a shared communication channel of the wireless communication network. The shared communication channel can be used by multiple devices communicating with another device. The communication can also be performed between the first wireless communication device and a plurality of second wireless communication devices.

At 520, information can be received about a third wireless communication device operating in the wireless communication network. A device of the first, second, and third wireless communication devices can be a user equipment, an AP, a wireless terminal, a wireless communication station (STA), and/or any other device that can communicate on a shared channel of a wireless communication network. The information can include at least one transition time between awake and sleep states of a radio transceiver of the third wireless communication device. The information can be information about transition times of just the third wireless communication device, transition times of multiple devices, transition times in multiple transceivers in the third wireless communication device, and/or transition times in multiple transceivers of multiple devices. The transition time that is the best, such as the longest, for all of multiple transceivers and devices can be chosen as a representative transition time to allow all STAs to microsleep or the transition time can be chosen based on other criteria. The information can include a transition time from an awake state to a sleep state, can include a transition time from a sleep state to an awake state, can include various transition times between sleep and awake states, and/or can include other information about a transition time between awake and sleep states of the radio transceiver of the third wireless communication device and/or other devices. The sleep state can be a microsleep state that can be enabled in a wireless transceiver based on an evaluation of channel conditions, based on traffic characteristics, and based on other conditions. During microsleep, a transceiver of a device can enter a sleep state, such as by deactivating the transceiver, for a portion of a transmission time interval that carries traffic data that is not targeted to the device.

At 530, the duration of the data transmission to the second wireless communication device can be adjusted based on the at least one transition time between awake and sleep states of the radio transceiver of the third wireless communication device. The duration of data transmission can be a first duration of data transmission used in the wireless communication network and the adjusted duration of the data transmission can be a second duration of data transmission that accounts for awake and sleep transition times. The adjusted duration can be for a communication initiated by the first wireless communication device with the second wireless communication device and/or can be for an already existing communication between the first wireless communication device and the second wireless communication device.

Adjusting can include extending the duration of the data transmission to the second wireless communication device to a duration longer than the transition time between the awake and sleep states of the radio transceiver of the third wireless communication device. For example, the duration can be longer than a shortest transition time of transition times between awake and sleep states of the third wireless communication device radio transceiver, can be longer than a longest transition time of transition times between awake and sleep states of the third wireless communication device radio transceiver, and/or can be longer than any other transition time between awake a sleep states. This extended duration of the data transmission can allow for microsleep of the third wireless communication device, microsleep of the third wireless communication device radio transceiver, and/or microsleep of other features of the third wireless communication device.

The duration longer than the transition time can be based on a combination of transmitted data length and a PHY data transmission rate that provides a data transmission duration longer than the transition time between the awake and sleep states of the radio transceiver of the third wireless communication device. Different strategies can be used and/or attempted to make a decision subject to one or more performance indicators. The different strategies can include different transmission times, different types of multiple frame transmissions, different types of frame aggregation, different reduced PHY data transmission rates, and/or other different strategies. For example, the transmission duration can be increased to be longer than the transition time between the awake and sleep states by allowing multiple frame transmissions, frame aggregation, and/or by reducing the PHY data transmission rate.

The performance indicators can include Quality of Service (QoS), fairness, reliability, and other performance indicators. For a fairness performance indicator, all devices may use the same rules and a receiving device may be allowed to send back data in a reverse direction if performance indicators allow it. The receiving device can know that other STAs go to sleep and also that it has high QoS where it can be granted immediate channel access opportunity. Alternately, fairness can be employed because it may not be fair to allow a device to access to a channel without competing, such as where other STAs have a higher QoS.

Extending the duration can include increasing a transmitted data length multiple frame transmission and/or frame aggregation. For example, multiple frame transmission can include frame bursting or other multiple frame transmissions. Also, frame aggregation can include an MPDU, Aggregated MSDU (A-MSDU), and/or other frame aggregation. Extending the duration can also include reducing a PHY data transmission rate. For example, the PHY data transmission rate can be reduced from a highest rate to a lowest rate, which can be more robust against channel errors. Extending the duration can further include extending the duration in a TXOP of the data transmission to the second wireless communication device based on information about the third wireless communication device, where the first wireless communication device can gain access to a communication channel with the second wireless communication device for a reserved period of time.

According to a possible implementation, data can be transmitted in a first duration of data transmission when there is no information including at least one transition time between awake and sleep states of a radio transceiver of the third wireless communication device. Also data can be transmitted in a second duration of data transmission to the second wireless communication device. The second duration can be adjusted from the first duration based on the at least one transition time between awake and sleep states of the radio transceiver of the third wireless communication device.

At 540, information including information about the adjusted duration of the data transmission can be transmitted. For example, other devices can be informed in transmitted control and/or data frames of the expected transmission duration. Control frames can include RTS frames, CTS frames, ACK frames, and other control frames. Data frames can include transmitted data, received data, and other data frames.

When communicating with a second wireless communication device at 510, a grant can be received from the second wireless communication device to transmit data on a channel in the wireless communication network. The grant can be implicitly received because just receiving a frame may be understood as an implicit grant. Also, the grant can be explicitly received in a frame including an explicit grant to transmit data on the channel The grant can be used for an RD mode. For example, according to some embodiments, the second wireless communication device can be a transmission initiating device, such as an RD initiator, that gains access to the channel via the TXOP and initiates the transmission. According to other embodiments, the second wireless communication device can be a transmission receiving device, such as an RD responder that receives the transmission and receives a grant from the transmission initiating device to send data back during the unused portion of its TXOP or an extended TXOP. In an RD mode and/or RD protocol, such as an 802.11n RD protocol, the first or second wireless communication device can be a receiving device that receives the grant from the transmission initiating device. If the wireless communication device, such as a receiving STA, does not have enough time to transmit its data, it may not use the grant. The RD mode can be proactive in that a transmitting device with the TXOP can decide whether a receiving device can transmit data in the reverse direction. The RD mode can also be reactive in that the receiving device can decide whether or not it can transmit data in the reverse direction. In proactive RD the receiving device can only send data back during the unused part of the TXOP of the transmitting device. However, in reactive RD a receiving device can extend the TXOP of the transmitting device as required according to traffic status or based on a given performance indicator. As opposed to proactive RD, in reactive RD the TXOP can be extended and can facilitate microsleep for other devices.

The transmitting device with the TXOP can be called a TXOP holder whereas the receiving device of the TXOP can be called a TXOP responder. The terms TXOP holder and TXOP responder can be used to identify the roles of the devices involved in an RD exchange sequence depending on whether the RD operation is proactive, such as that of the 802.11n RD protocol, or reactive. In proactive RD, the RD initiator can be the TXOP holder and the RD responder can be the TXOP responder. In contrast, in reactive RD, the RD initiator can be the TXOP responder and the RD responder can be the actual TXOP holder. In either case, the third wireless communication device can microsleep when the transmission duration is longer than a duration of transitions between awake and sleep states. The received grant from the second wireless communication device may be in an RTS frame from the second wireless communication device and the grant may also be included in a data frame transmitted by the second wireless communication device. The grant may not be mandatory to allow the first wireless communication device to send data or not send data to the second wireless communication device. Also, just the reception of an RTS frame, CTS frame, or a data frame may trigger a subsequent RD transmission with no grant included in such frames.

When operating in an RD mode, at 530, the duration of the data transmission to the second wireless communication device can be adjusted to a duration longer than the transition time between the awake and sleep states of the radio transceiver of the third wireless communication device. The duration can also be adjusted based on data length and rate, multiple frame transmission, reducing PHY data transmission rate, and/or other factors.

Also, when operating in an RD mode, the first wireless communication device can respond to the grant from the second wireless communication device with a transmission including information having the adjusted duration for the data transmission to the second wireless communication device. For example, the first wireless communication device can respond with a control or data frame with the duration updated to cover an RD transfer that may include frame bursting and/or frame aggregation. The first wireless communication device can then take control of the channel to initiate multiple data exchanges with multiple APs and/or non-AP STAs. There can be multiple RD transmissions with multiple devices where the device receiving data can take control of the channel and can exchange data with other STAs. The multiple device exchange procedure can also involve multiple channels.

For example, a wireless device that receives data from another wireless device may take control of the channel and behave as a master device, such as the role of an AP. This device can then initiate a data transmission phase, such as a contention-free data transmission phase, in which it exchanges data with multiple wireless devices, such as slave wireless devices. Within this controlled access phase, each slave device receiving data from the master device can be allowed to respond with data. In each data exchange, the master device can act as the source, whereas each slave device can act as the destination, and both devices can transmit and receive data while other slave devices can sleep. The contention-free period can continue until a certain requirement or condition is met. For example, the contention-free period can continue until all slave devices have received data once, can continue until the master device has no data to transmit to a given slave device, can continue until a slave device has no data to transmit to the master device, can continue based on traffic status, can continue as long as a performance indicator allows it, can continue based on maximum channel occupancy time, can continue based on maximum number of transmitted frames, can continue based on fairness, can continue based on reliability, can continue based on QoS, can continue until there are no more new devices to communicate with, and/or can continue until any other requirement or condition is met. In some cases, a device may not become a master device because there is already a master device in operation. In this case, the device can behave as a slave being able to send data to the master device when receiving data from the master device and can sleep based on the duration of data transmission when it is not transmitting or receiving data within the multiple device exchange period.

To elaborate, a first device can communicate with a second device. The second device can have data to send to a third device and a fourth device and the third and fourth devices can have data to transmit to the second device. The first device can send data to the second device. Then, the second device can behave as a master device and send data to the third device. The second device can take control of a channel just by the fact of receiving a frame from another device or by receiving a frame with an explicit grant to become a master device. There may only be one master device during a multiple device exchange opportunity. Meanwhile, the fourth device can sleep during the data transfer involving the first, second, and third devices. The first device can also sleep during the data transfer from the second to the third device. After the third device receives data from the second device, it can send data to the second device. Then, the second device can send data to the fourth device. The first device can sleep during the data transfer involving the second, third, and fourth devices. The third device can also sleep during the data transfer from the second to the fourth device. This procedure can continue for more devices. During the whole multiple device exchange sequence, all the devices involved in transmission can adjust their duration of data transmission being aware of the transition times of other devices that can potentially sleep.

For example, any device can continuously monitor the channel After a busy channel period, it can know when a new device seizes control of the channel By receiving frames from such device, it can determine the destination address of the frames. Such destination device can be the potential master device. If a device receives a subsequent data frame from such device, it can know that there is a master device in operation. This can be an approach where each device discovers the information about master and slave devices in each channel access opportunity. There can also be some signaling where the device receiving a frame from another device, after a busy channel period, can first send a broadcast/multicast-group-based frame to indicate that it will take the role of a master device before sending data to the slave devices. Or it can send a frame where it indicates it will not take the role of master device and leaves this role to other interested devices that can request this role. Creating clusters with a master and various slaves can implement efficient cooperative microsleep operation. Another implementation can include a first phase where the roles of master and slave devices are established in a random or deterministic manner for a certain time and the master/slave selection criteria can depend on device battery status, coverage, and other master/slave selection criteria.

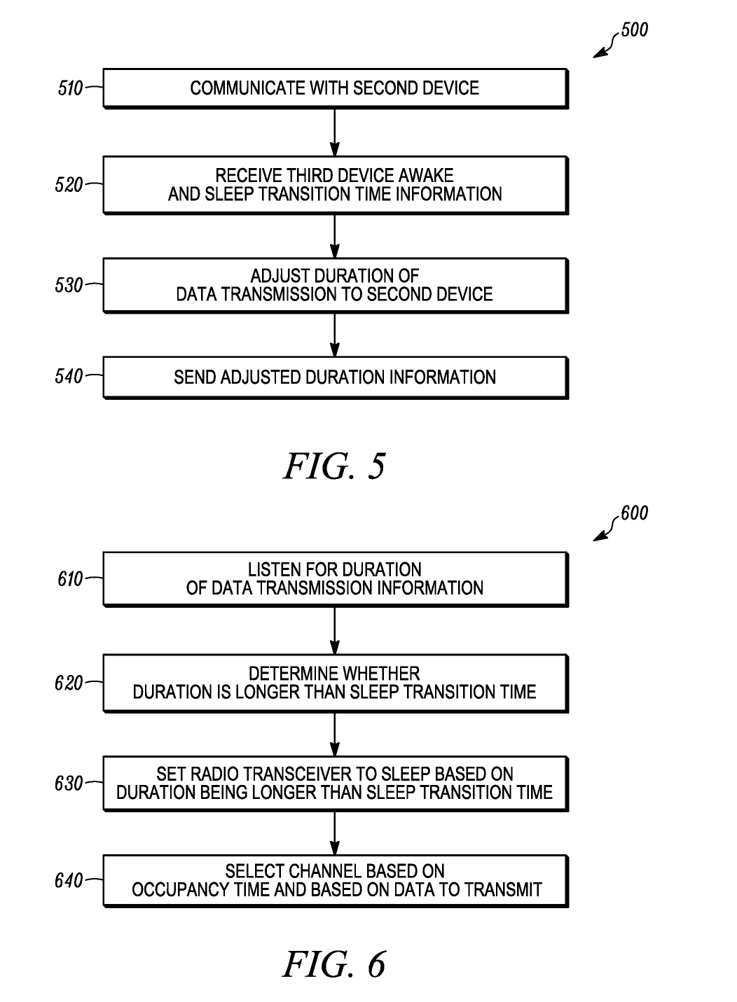

FIG. 6 is an example flowchart 600 illustrating the operation of a wireless communication device, such as the device 111 or any other wireless communication device, according to a possible embodiment. At 610, duration of data transmission information for a data transmission in a wireless communication network can be listened for. For example, when a device is not transmitting or receiving, it can listen for, such as overhear, duration of data transmission information by reading the duration information of overheard control and/or data frames, such as RTS frames, CTS frames, ACK frames, and data signals, to determine whether it can sleep in light of its transition time between awake and sleep states. In this case, the first wireless communication device can be the device for which the other devices adjust their duration of transmission.

At 620, whether the duration of data transmission information indicates the duration of data transmission is longer than a transition time between awake and sleep states of a radio transceiver of the first wireless communication device can be determined. At 630, the radio transceiver of the first wireless communication device can be set to a sleep state based on the duration of data transmission being longer than the transition time between awake and sleep states. Setting can include setting the radio transceiver of the first wireless communication device to enter the sleep state at the beginning of the data transmission and return to the awake state at the end of the data transmission based on the duration of data transmission being longer than a transition time between awake and sleep states.

Determining at 620 can include setting a NAV timer based on the duration of data transmission information and determining whether the NAV timer time is longer than a transition time between awake and sleep states of a radio transceiver of the device. Then, setting at 630 can include setting the radio transceiver to a sleep state based on the NAV timer time being longer than the transition time between awake and sleep states of a radio transceiver of the first wireless communication device. For example, a NAV can represent a number of microseconds that a transmitting device intends to hold a channel busy. The first wireless communication device can set its NAV timer based on a duration field of a received frame and can compute a duration of the sleep state as the NAV timer time minus the transition time between awake and sleep states of a radio transceiver of the device.

At 640, a channel can be selected based on channel occupancy time and based on whether the first device has data to transmit. For example, the wireless communication network can include a plurality of channels and at least one channel of the plurality of channels can be occupied by at least one other wireless communication device for an occupancy time. A channel with a shortest occupancy time can be selected when the first wireless communication device has data to transmit. Alternately, a channel with a longest occupancy time can be selected when the first wireless communication device has no data to transmit. The first wireless communication device can select the channel with the occupancy time that better suits its instantaneous traffic requirements. The device can select a channel with the longest occupancy time of a plurality of channels in the wireless communication network if the device has no data to transmit to allow the device to sleep longer.

To elaborate, busy channel periods can be exploited to allow the device to sleep. Depending on whether the device has data to transmit or not, it can give priority to a channel of a plurality of channels with a shorter occupancy or to a channel of a plurality of channels with a longer occupancy. In any case, the device can attempt to sleep. For example, the first device can choose the preferred channel occupancy time based on traffic status to attempt to sleep or sleep longer. The first device can determine if the occupancy time of the selected channel is longer than its transition time between awake and sleep states. This can allow the first device to sleep during a second device data transmission through different channels. The second device can transmit on all the available channels while providing the transmission duration information in each channel The first device can record this information and can choose the channel with the most appropriate occupancy time based on its traffic requirements.

If the first device has data to send, it can choose the channel with the lowest occupancy time and can try to sleep based on this duration. If all available channels are busy, the first device may have to wait anyway at least until one of the channel is free to attempt to transmit on that channel. In this case, the first device can give priority to the fact that it has data to send, and sleeping to save energy can be less important at this time. The first device can choose a channel with a certain occupancy time that better suits its instantaneous traffic requirements to attempt to sleep. These requirements can include a performance and/or QoS indicator. For example, given a performance indicator, the device may decide to sleep for the longest channel occupancy time even if it has data to transmit, as long as this decision does not compromise its performance, but improves its energy efficiency. Otherwise, if the first device has no data to send, it can choose the channel with the highest occupancy time and can try to sleep based on this duration. In this case, the first device can give priority to sleeping to save energy.

According to a possible implementation, the first wireless communication device can determine an instantaneous traffic requirement of the first wireless communication device. It can then select a channel with a longest occupancy time when the selection improves the energy efficiency of the first wireless communication device while not compromising the instantaneous traffic requirement. For example, the device can choose the channel with a certain occupancy time that better suits its instantaneous traffic requirements to attempt to sleep. These requirements can be based on a performance indicator, a QoS indicator, or any other indicator that reflects instantaneous traffic requirements. To elaborate, given a performance indicator, a device can decide to sleep for the longest channel occupancy time even if it has data to transmit, if this decision does not compromise its performance but improves its energy efficiency.

It should be understood that, notwithstanding the particular steps as shown in the figures, a variety of additional or different steps can be performed depending upon the embodiment, and one or more of the particular steps can be rearranged, repeated or eliminated entirely depending upon the embodiment. Also, some of the steps performed can be repeated on an ongoing or continuous basis simultaneously while other steps are performed. Furthermore, different steps can be performed by different elements or in a single element of the disclosed embodiments.

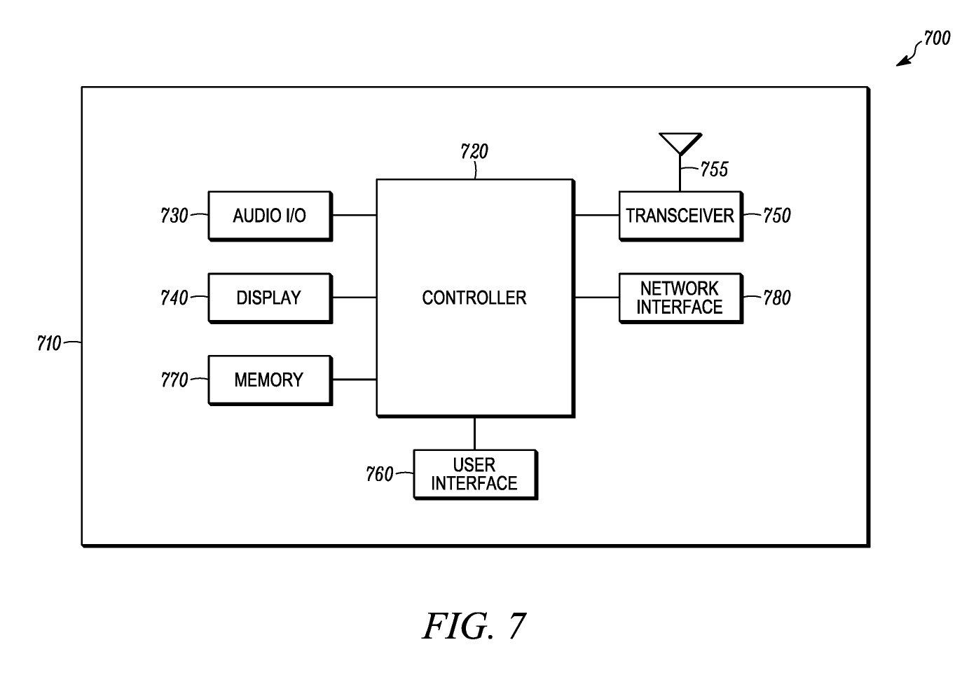

FIG. 7 is an example block diagram of an apparatus 700, such as the wireless communication device 111 or any other wireless communication device, such as an AP or an STA, according to a possible embodiment. The apparatus 700 can include a housing 710, a controller 720 within the housing 710, audio input and output circuitry 730 coupled to the controller 720, a display 740 coupled to the controller 720, a transceiver 750, such as a radio transceiver, coupled to the controller 720, an antenna 755 coupled to the transceiver 750, a user interface 760 coupled to the controller 720, a memory 770 coupled to the controller 720, and a network interface 780 coupled to the controller 720. The apparatus 700 can perform the methods described in all the embodiments.

The display 740 can be a viewfinder, a Liquid Crystal Display (LCD), a Light Emitting Diode (LED) display, a plasma display, a projection display, a touch screen, or any other device that displays information. The transceiver 750 can be a radio transceiver that includes a transmitter and/or a receiver. The audio input and output circuitry 730 can include a microphone, a speaker, a transducer, or any other audio input and output circuitry. The user interface 760 can include a keypad, a keyboard, buttons, a touch pad, a joystick, a touch screen display, another additional display, or any other device useful for providing an interface between a user and an electronic device. The network interface 780 can be a Universal Serial Bus (USB) port, an Ethernet port, an infrared transmitter/receiver, an IEEE 1394 port, another transceiver, or any other interface that can connect an apparatus to a network, device, or computer and that can transmit and receive data communication signals. The memory 770 can include a random access memory, a read only memory, an optical memory, a flash memory, a removable memory, a hard drive, a cache, or any other memory that can be coupled to an apparatus.

The apparatus 700 or the controller 720 may implement any operating system, such as Microsoft Windows®, UNIX®, or LINUX®, Android™, or any other operating system. Apparatus operation software may be written in any programming language, such as C, C++, Java or Visual Basic, for example. Apparatus software may also run on an application framework, such as, for example, a Java® framework, a .NET® framework, or any other application framework. The software and/or the operating system may be stored in the memory 770 or elsewhere on the apparatus 700. The apparatus 700 or the controller 720 may also use hardware to implement disclosed operations. For example, the controller 720 may be any programmable processor. Disclosed embodiments may also be implemented on a general-purpose or a special purpose computer, a programmed microprocessor or microprocessor, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, the controller 720 may be any controller or processor device or devices capable of operating an apparatus and implementing the disclosed embodiments.

In operation, the radio transceiver 750 can communicate with a second apparatus in a wireless communication network having a duration of data transmission. The radio transceiver 750 can receive information about a third apparatus operating in the wireless communication network. The information can include at least one transition time between awake and sleep states of a radio transceiver of the third apparatus. The controller 720 can adjust the duration of the data transmission to the second apparatus based on the at least one transition time between awake and sleep states of the radio transceiver of the third apparatus. Adjusting can include extending the duration of the data transmission to the second apparatus to a duration longer than the transition time between the awake and sleep states of the radio transceiver of the third apparatus.

Communicating with a second apparatus can include receiving a communication from the second apparatus having a duration of data transmission on a channel in a wireless communication network. The radio transceiver 750 can receive a grant from the second apparatus to transmit data on the channel. The controller 720 can adjust the duration of the data transmission for a transmission to the second apparatus based on at least one transition time between awake and sleep states of the radio transceiver of the third apparatus.

The radio transceiver 750 can listen for duration of data transmission information for a data transmission in the wireless communication network. The controller 750 can determine whether the duration of data transmission information indicates the duration of data transmission is longer than a transition time between awake and sleep states of a radio transceiver of the apparatus 700. The controller 720 can set the radio transceiver 750 of the apparatus 700 to a sleep state based on the duration of data transmission being longer than the transition time between awake and sleep states.

The wireless communication network can include a plurality of channels. At least one channel of the plurality of channels can be occupied by at least one other apparatus for an occupancy time. The controller 720 can select a channel with a shortest occupancy time when the apparatus 700 has data to transmit. Alternately, the controller 720 can select a channel with a longest occupancy time when the apparatus 700 has no data to transmit. This can allow the radio transceiver 750 to microsleep based on the occupancy time of the selected channel

The method of this disclosure can be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The phrase “at least one of,” “at least one selected from the group of,” or “at least one selected from” followed by a list is defined to mean one, some, or all, but not necessarily all of, the elements in the list. The terms “comprises,” “comprising,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.” Furthermore, the background section is written as the inventor's own understanding of the context of some embodiments at the time of filing and includes the inventor's own recognition of any problems with existing technologies and/or problems experienced in the inventor's own work.

We claim:

1. A method in a first wireless communication device, the method comprising:
communicating with a second wireless communication device in a wireless communication network having a duration of data transmission;
receiving information about a third wireless communication device operating in the wireless communication network, where the information includes at least one transition time between awake and sleep states of a radio transceiver of the third wireless communication device; and
adjusting the duration of the data transmission to the second wireless communication device based on the at least one transition time between awake and sleep states of the radio transceiver of the third wireless communication device.

2. The method according to claim 1, wherein adjusting comprises extending the duration of the data transmission to the second wireless communication device to a duration longer than the transition time between the awake and sleep states of the radio transceiver of the third wireless communication device.

3. The method according to claim 2, wherein the duration longer than the transition time is based on a combination of transmitted data length and a physical data transmission rate that provides a data transmission duration longer than the transition time between the awake and sleep states of the radio transceiver of the third wireless communication device.

4. The method according to claim 2, wherein extending the duration comprises increasing a transmitted data length using at least one selected from multiple frame transmission and frame aggregation.

5. The method according to claim 2, wherein extending the duration comprises reducing a physical data transmission rate.

6. The method according to claim 2, wherein extending the duration comprises extending the duration in a transmission opportunity of the data transmission to the second wireless communication device based on information about the third wireless communication device, where the first wireless communication device gains access to a communication channel with the second wireless communication device for a reserved period of time.

7. The method according to claim 1, further comprising transmitting information including information about the adjusted duration of the data transmission.

8. The method according to claim 1, wherein communicating with a second wireless communication device comprises receiving a grant from the second wireless communication device to transmit data on a channel in the wireless communication network.

9. The method according to claim 8,
wherein the second wireless communication device controls the channel, and
wherein the method further comprises:
assuming control of the channel from the second wireless communication device; and
exchanging data with at least one fourth wireless communication device different from the second wireless communication device.

10. The method according to claim 8, wherein adjusting comprises adjusting the duration of the data transmission to the second wireless communication device to a duration longer than the transition time between the awake and sleep states of the radio transceiver of the third wireless communication device.

11. The method according to claim 8, further comprising responding to the grant from the second wireless communication device with a transmission including information having the adjusted duration for the data transmission to the second wireless communication device.

12. The method according to claim 1, further comprising:
listening for duration of data transmission information for a data transmission in the wireless communication network;
determining whether the duration of data transmission information indicates the duration of data transmission is longer than a transition time between awake and sleep states of a radio transceiver of the first wireless communication device; and
setting the radio transceiver of the first wireless communication device to a sleep state based on the duration of data transmission being longer than the transition time between awake and sleep states.

13. The method according to claim 12, wherein setting comprises setting the radio transceiver of the first wireless communication device to enter the sleep state at the beginning of the data transmission and return to the awake state at the end of the data transmission based on the duration of data transmission being longer than a transition time between awake and sleep states.

14. The method according to claim 12,
wherein the wireless communication network includes a plurality of channels and at least one channel of the plurality of channels is occupied by at least one other wireless communication device for an occupancy time, and
wherein the method further comprises selecting a channel with a shortest occupancy time when the first wireless communication device has data to transmit.

15. The method according to claim 12,
wherein the wireless communication network includes a plurality of channels and at least one channel of the plurality of channels is occupied by at least one other wireless communication device for an occupancy time, and
wherein the method further comprises selecting a channel with a longest occupancy time when the first wireless communication device has no data to transmit.

16. The method according to claim 12,
wherein the wireless communication network includes a plurality of channels and at least one channel of the plurality of channels is occupied by at least one other wireless communication device for an occupancy time, and
wherein the method further comprises:
determining an instantaneous traffic requirement of the first wireless communication device; and
selecting a channel with a longest occupancy time when the selection improves the energy efficiency of the first wireless communication device while not compromising the instantaneous traffic requirement of the first wireless communication device.

17. An apparatus comprising:
a radio transceiver that communicates with a second apparatus in a wireless communication network having a duration of data transmission and receives information about a third apparatus operating in the wireless communication network, where the information includes at least one transition time between awake and sleep states of a radio transceiver of the third apparatus; and
a controller that adjusts the duration of the data transmission to the second apparatus based on the at least one transition time between awake and sleep states of the radio transceiver of the third apparatus.

18. The apparatus according to claim 17, wherein adjusting comprises extending the duration of the data transmission to the second apparatus to a duration longer than the transition time between the awake and sleep states of the radio transceiver of the third apparatus.

19. The apparatus according to claim 17,
wherein communicating with a second apparatus comprises receiving a communication from the second apparatus having a duration of data transmission on a channel in a wireless communication network,
wherein the radio transceiver receives a grant from the second apparatus to transmit data on the channel, and
wherein adjusting comprises adjusting the duration of the data transmission for a transmission to the second apparatus based on the at least one transition time between awake and sleep states of the radio transceiver of the third apparatus.

20. The apparatus according to claim 17,
wherein the radio transceiver listens for duration of data transmission information for a data transmission in the wireless communication network, and
wherein the controller determines whether the duration of data transmission information indicates the duration of data transmission is longer than a transition time between awake and sleep states of a radio transceiver of the apparatus, and sets the radio transceiver of the apparatus to a sleep state based on the duration of data transmission being longer than the transition time between awake and sleep states.

21. The apparatus according to claim 20,
wherein the wireless communication network includes a plurality of channels and at least one channel of the plurality of channels is occupied by at least one other apparatus for an occupancy time, and
wherein the controller selects a channel with a shortest occupancy time when the apparatus has data to transmit.

22. The apparatus according to claim 20,
wherein the wireless communication network includes a plurality of channels and at least one channel of the plurality of channels is occupied by at least one other apparatus for an occupancy time, and
wherein the controller selects a channel with a longest occupancy time when the apparatus has no data to transmit.
